(19) United States
(12) Patent Application Publication
(10) Pub. No.: US 2023/0094956 A1
(43) Pub. Date: Mar. 30, 2023

(54) LIFTING DEVICE AND ASSOCIATED METHODS

(71) Applicant: Redline Innovations, Inc, Indian Harbour Beach, FL (US)

(72) Inventors: Michael Pannucci, Melbourne, FL (US); Robert Clark, Melbourne, FL (US)

(21) Appl. No.: 17/936,171

(22) Filed: Sep. 28, 2022

Related U.S. Application Data
(60) Provisional application No. 63/250,531, filed on Sep. 30, 2021.

(51) Int. Cl. A61G 7/10

(52) U.S. Cl. CPC A61G 7/1015; A61G 7/1046; A61G 7/1019; A61G 7/1059; A61G 2203/12

(57) ABSTRACT

A lifting device including a top member, a pair of side members, a plurality of shield members, and a hoist member. The pair of side members may be attached to the top member and may have a plurality of leg members. The plurality of shield members may be attached to and extending between an upper portion of the pair of side members. The hoist member may be attached to a portion of the top member and may have a load member that may be carried within the hoist member. The hoist member may be configured to rotate the load member between a wound position and an unwound position. The top member and the plurality of shield members may be configured to move between a collapsed position and an extended position.

### RELATED APPLICATIONS

This application claims priority under 35 U.S.C. § 119(e) of U.S. Provisional Patent Application Ser. No. 63/250,531 (Attorney Docket No. 901.00004) filed on Sep. 30, 2021 and titled LIFTING DEVICE AND ASSOCIATED METHODS. The content of this application is incorporated herein by reference.

### FIELD OF THE INVENTION

The present invention relates a lifting device and, more specifically, to a lifting device for use in the healthcare field to assist with lifting of patients in various medical scenarios.

### BACKGROUND OF THE INVENTION

In many lines of work there are occasions that involve lifting and sometimes carrying an individual who is incapable of picking themselves off the ground, or incapable of moving from one place to another, such as from a chair to a bed, or a bed to another bed. It can often be difficult or dangerous for a worker to lift such individuals, especially if the worker is small in stature, or when the individual in need of help is heavier set. These dangerous situations run the risk of causing injury and/or discomfort to either the worker or the individual in need of help.

This has created a need for a device that can be used to lift individuals in a safer manor to reduce that chances of injuries or discomfort from taking place. Especially incases where the individual in need of assistance is larger than the worker trying to assist the individual. There are some devices already available in the prior art which attempt to remedy these situations. Such as U.S. Pat. No. 9,814,644 (hereinafter “the '644 patent”) for a “lifting device and associated methods. The '644 patent was useful and has help a number of people over the years, but it became apparent over time there was a need for a device that could laterally expand to be used to lift individuals from or around furniture and objects.

It also became apparent that wheels could not be added to the '644 patent since it would make it unstable, so a wider more stable structure of a lifting device would be needed so that wheels could be added to the lifting device for transporting lifted individuals. Moreover, there was an apparent need for a lifting device that could be horizontally expandable and contractible, so that the lifting device could be used over a variety of furniture, objects, and environments. Ideally, a lifting device would contain these features and also be disassemble-able for ease of transportation and storing the lifting device when the lifting device is not in use.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a lifting device including a top member, a pair of side members, a plurality of shield members, and a hoist member. The pair of side members may be attached to the top member and may have a plurality of leg members. The plurality of shield members may be attached to and extending between an upper portion of the pair of side members. The hoist member may be attached to a portion of the top member and may have a load member that may be carried within the hoist member.

The hoist member may be configured to rotate the load member between a wound position and an unwound position. The top member and the plurality of shield members may be configured to move between a collapsed position and an extended position. The plurality of leg members may be movable between an extended position and a collapsed position. The pair of side members may have a plurality of through holes formed therethrough. An embodiment of the present invention may include a locking mechanism carried by a portion of each of the leg members. The locking mechanism may be configured to move between a locked state and an unlocked state.

The locked state may be defined as the locking mechanism engaging a pair of the through holes formed in the side members. The unlocked state may be defined as the locking mechanism not engaging the pair of through holes formed in the side members. When the locking mechanism is in the unlocked state, the plurality of legs may be slidably moveable with respect to the respective side members. When the locking mechanism is in the locked state, the plurality of legs may be fixedly positioned with respect to the side members.

The plurality of leg members may include a plurality of foot connection members. The foot connection members may include casters. An embodiment of the present invention may also include one or more U-shaped members that may be attached to a bottom side of the top member. The hoist member may be coupled in communication with a remote device. The hoist member may be configured to be controlled by the remote device via user inputs on the remote device. The communication between the remote device and the hoist member may be wired and/or wireless communication.

An embodiment of the present invention may also include a pair of overlay members. The pair of overlay members may be connected to a support member that may be extending between portions of the side members. The pair of overlay members may be horizontally aligned with one another. The pair of overlay members may be configured to carry a bench seat.

The top member may have a medial portion and a pair of side portions that may be slidably connected to the medial portion. The medial portion may include a pair of cavities that may be configured to receive the side portions. The collapsed position of the top member may be defined as the pair of side portions being slid into the cavities. The extended position of the top member may be defined as the pair of side members being extended out from the pair of cavities.

The top member may further include a top handle member that may be positioned on an upper portion of the top member and opposing side handle members that may be connected to each of the side portions so that each of the side portions of the top member may include one side handle member. The shield members may include a first shield member, a second shield member, and a center shield member.

A side of the center shield member may be attached to the second shield member. Another side of the center shield member may be slidably attached to the first shield member. The plurality of shield members may be configured to move between a collapsed position and an extended position. The collapsed position may be defined as the center shield member being substantially covered by the first shield member. The extended position may be defined as a portion of the center shield member being uncovered by the first shield member.

The second shield member may include a shield lock. The shield lock may be configured to move between a locked state and an unlocked state. When the shield lock is in the locked state, the first shield member may be prevented from sliding with respect to the center shield member. When the shield lock is in the unlocked sate, the first shield member may be slidable with respect to the center shield member.

The pair of side members may be removably attachable to the top member. The shield members may be removably attachable to the side members. The lifting device may be moveable between a disassembled state and an assembled state. The disassembled state may be defined as the pair of side members being detached from the top member and the plurality of shield members being detached from the pair of side members. The assembled state may be defined as the pair of side members being attached to the top member and the plurality of shield members being attached to the pair of side members.

### BRIEF DESCRIPTION OF THE DRAWINGS

Some embodiments of the present invention are illustrated as an example and are not limited by the figures of the accompanying drawings, in which like references may indicate similar elements.

FIG. 1 is a perspective view of a lifting device according to the present invention.

FIG. 2 is a perspective view of an upper portion of the lifting device illustrated in FIG. 1.

FIG. 3 is a perspective view of the lifting device illustrated in FIG. 1 in use to lift a person over an item of furniture.

FIG. 4 is a perspective view of the lifting device illustrated in FIG. 1 in use to suspend a person above the ground.

FIG. 5 is a perspective view of the lifting device illustrated in FIG. 1 in a horizontally collapsed position and a vertically extended position and in use to suspend a person above the ground.

FIG. 6 is a perspective view the lifting device illustrated in FIG. 5 in a horizontally collapsed position and a vertically collapsed position.

FIG. 7 is a perspective and environmental view of the lifting device illustrated in FIG. 1 in a horizontally collapsed position and a vertically extended position being used to suspend a person above the ground while another person (or user) pushes and wheels the lifting device while the person is suspended.

FIG. 8 is a perspective view of an upper portion of the lifting device illustrated in FIG. 1 and in the horizontally extended position.

FIG. 9 is a perspective view of a remote of the lifting device illustrated in FIG. 1

FIG. 10 is a perspective and environmental view of the lifting device illustrated FIG. 1 in a disassembled state and being carried by a person.

FIG. 11 is a perspective view of the upper portion of the lifting device illustrated in FIG. 1 in a fully collapsed state.

FIG. 12 is an exploded perspective and environmental view of the lifting device illustrated in FIG. 1 that is disassembled and being carried by a person with an illustration of the placement of a front shield member on the lifting device.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a lifting device 27. The lifting device 27 according to embodiments of the present invention may advantageously be used to assist in lifting a person, such as a patient, from the ground. For example, the lifting device 27 may be used by hospital personnel to lift patients, or to assist patients that are not otherwise mobile, or who may need to be moved from one position to another, e.g. from a wheel chair to a bed. The lifting device 27 according to the present invention is also moveable between collapsed and extended positions, as will be discussed in greater detail below, and can therefore advantageously be used in connection with emergency personnel. More particularly, emergency personnel can readily collapse the lifting device 27 so that it can be stored on an emergency vehicle, such as an ambulance or a firetruck, for example. Those skilled in the art will appreciate that the lifting device 27 according to embodiments of the present invention may advantageously be used for any number of necessary lifting necessities in any number of different situations.

The lifting device 27 according to the present invention may be used to prevent back injury, for example, of personnel that may be responsible for lifting patients, or other persons. For example, and in reference to ambulance personnel, there are several calls to assist fallen patients. Back injuries may occur to ambulance personnel when attempting to lift such patients, especially when the patient is located on the ground. Using the lifting device 27 according to embodiments of the present invention may advantageously reduce, or even eliminate, such back injuries that ambulance personnel may sometimes suffer. A similar situation occurs when hospital personnel help patients from the ground or when assisting a patient in moving from one position to another. The lifting device 27 according to the present invention may be used to reduce the potential for such injuries.

Further, use of the lifting device 27 according to the present invention may greatly reduce the risk of injury to a patient. The process for lifting a patient that may be positioned on the ground, or moving the patient from one location to another, may be dangerous for the patient. The lifting device 27 according to embodiments of the present invention may advantageously be used to readily move the patient as necessary, while simultaneously reducing the risk of injury to the patient.

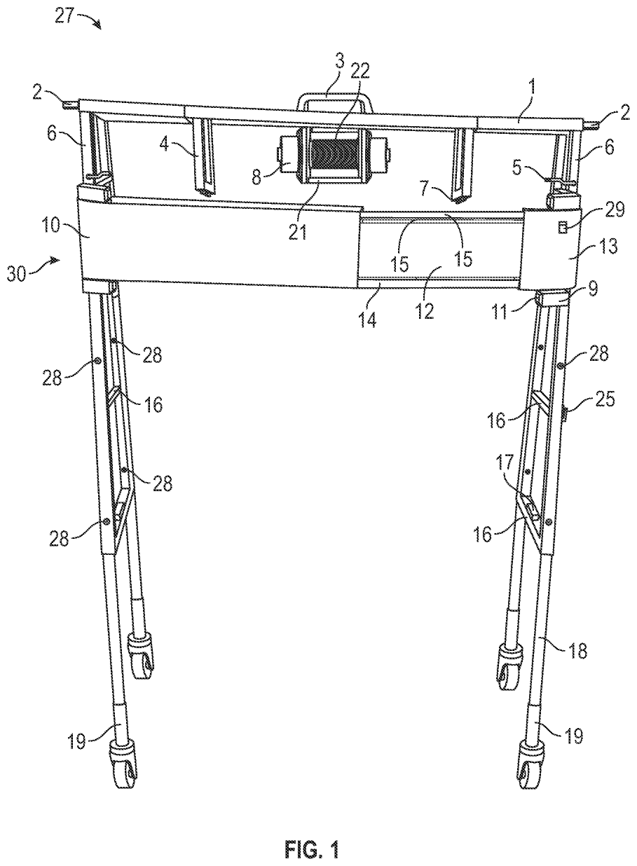

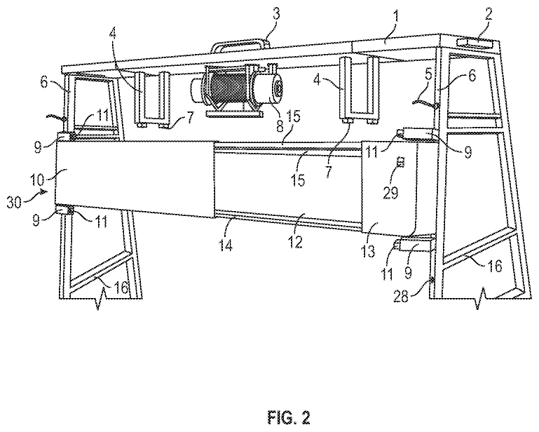

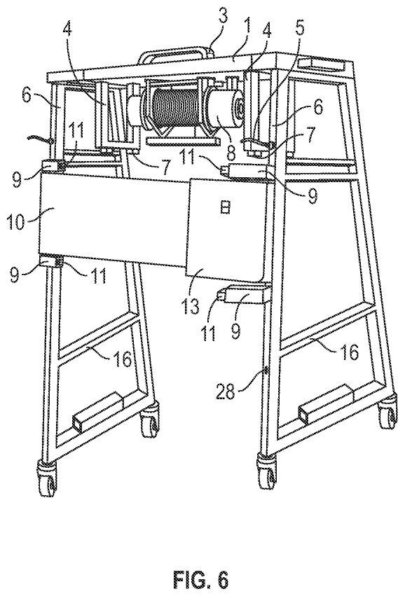

Referring now more specifically to FIGS. 1-12, additional features of lifting device 27 are now described in greater detail. More specifically, the lifting device 27 may comprise a top member 1 located at the upper area of the lifting device 27. As will be described in greater detail below, since the lifting device 27 is moveable between extended and collapsed positions, the top member 1 may also be moveable from an extended position to a collapsed position to minimized space required for storage of the lifting device and to allow for ease of transport of the lifting device 27 by a user, as perhaps best illustrated, for example, in FIGS. 6 & 10. The ease of transporting the device is further increased with the inclusion of a carry handle member 3 that may be used to carry the lifting device 27 when in a collapsed position. For example, the carry handle member 3 can be used when the lifting device 27 is being transported over rough terrain, ground, or to more easily carry the lifting device 27 as perhaps best illustrated in FIG. 9. While a single carry handle member 3 is shown, it is contemplated and included within the scope of the invention that any number of handles may be provided and that the handles may be located anywhere on the top member 1 or any other element of the lifting device 27 to advantageously facilitate lifting and carrying thereof.

The lifting device 27 may also comprise at the opposing ends of the top member 1 a side handle 2 on both ends. Each side handle 2 may be used to manipulate top member 1 when the lifting device 27 is fully assembled, disassembled, or collapsed or non-collapsed. Those skilled in the art will appreciate that the side handles 2 are an optional feature that provide additional advantages to the lifting device 27, and that the lifting device 27 may be provided with or without side handles 2 while still accomplishing the goals, features and advantages according to the present invention.

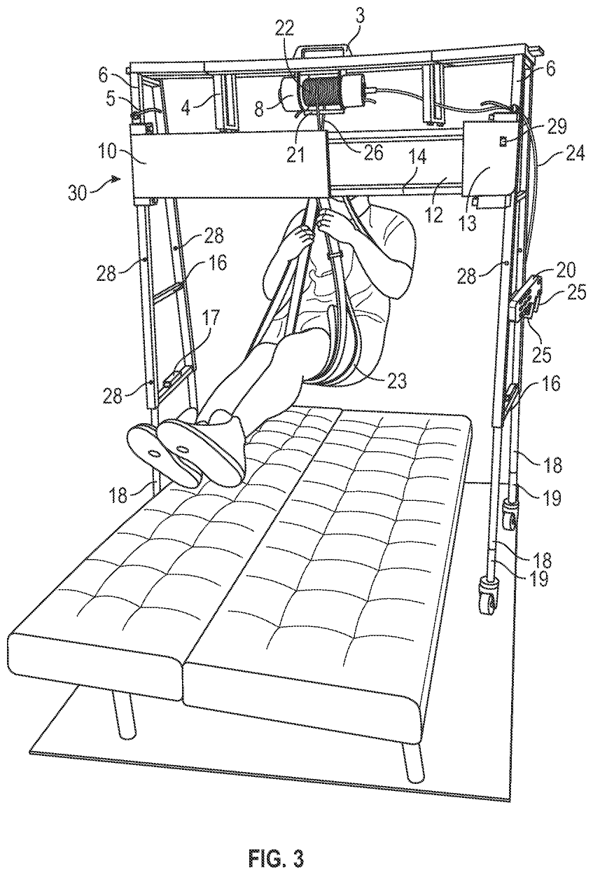

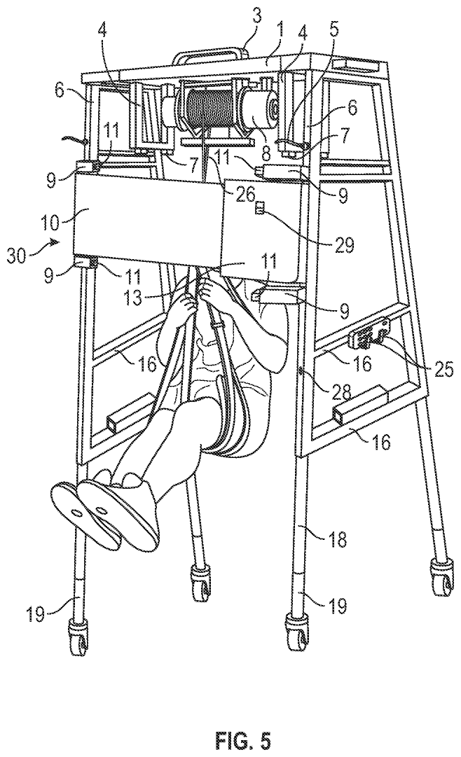

Referring now to FIGS. 1-4, & 11, the lifting device 27 according to embodiments of the present invention may further illustratively comprise a hoist assembly 8. The hoist assembly 8 may be fixedly attached to a lower surface of the top member 1. The hoist assembly 8 is illustrated as being positioned close to a center portion of the top member 1, but those skilled in the art will appreciate that the hoist assembly may be positioned anywhere in connection with the top member while still accomplishing the goals, features and advantages of the present invention. The hoist assembly 8 may be operable to supply the force necessary to lift a person or patient. The hoist assembly 8 can be configured to actuate a lifting force to lift a patient as described, depending on the intended application of the lifting device 27. The hoist assembly 8 may compose of a coiled member 22 located within the hoist assembly 8 fixedly connected to the hoist assembly 8 such that the coiled member 22 may have the ability to rotate about one of the coiled member's 22 axes. More specifically, the hoist assembly 8 may, for example, be provided by a winch. The hoist assembly 8 may further include a load member 26 that is rope-like and connected to the coiled member 22 that may be in a wrapped configuration so that the load member 26 is wound around the coiled member 22. A user operating the lifting device 27 may use the hoist assembly 8 to rotate the coiled member 22 around an axis such that the load member 26 is wound or unwound from around the coiled member 22 to control a person's position above the ground as illustratively shown in FIGS. 3, 5, & 7.

How a person is lifted with the lifting device is discussed in more detail below. The hoist assembly 8 may further comprise a bar member 21 extending the length of the coiled member 22 that may be included to ensure that the load member 26 does not tangle when wound or unwound from the coiled member 22, and to reduce other possible issues with the load member 26 when the lifting device 27 is in use. The functionality of the coiled member 22 and the load member 26 is discussed in more detail below.

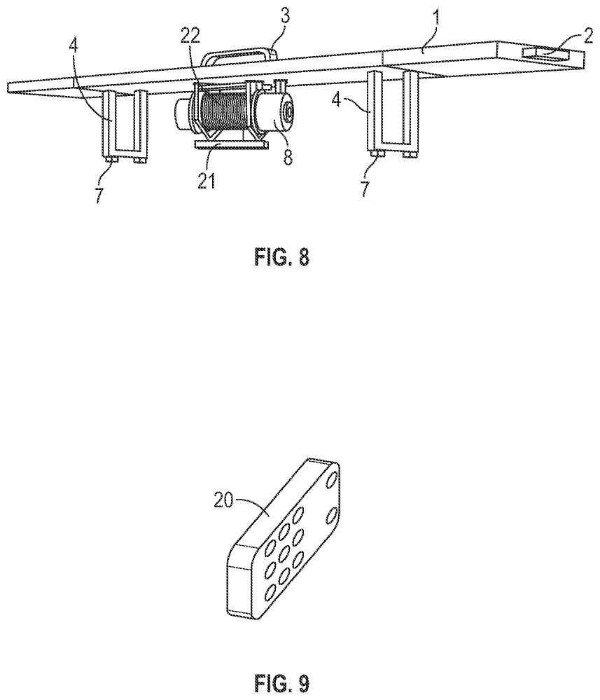

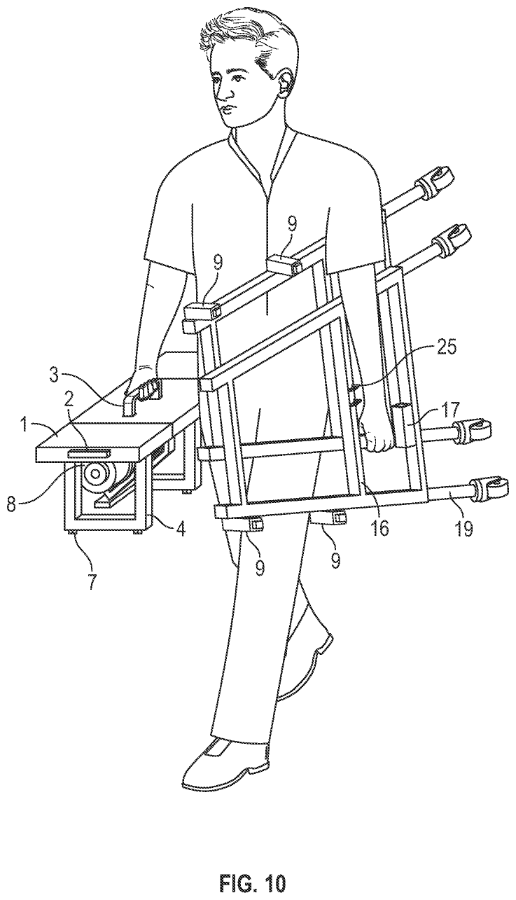

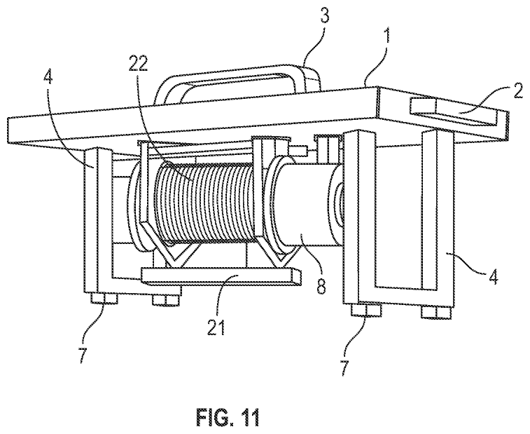

The lifting device 27 may also comprise a U-shaped member 4 located on the bottom side of top member 1 and near each end of the top member 1. As illustrated, for example, in FIG. 8, a pair of U-shaped members 4 may be provided and may be positioned on either end of the coiled member 22 to oppose one another. Each U-shaped member 4 may be placed such that each does not interfere with the ability for the lifting device 27 to collapse. Placement of the U-shaped members 4 when the lifting device is in its collapsed state is best illustratively shown in FIGS. 6 and 10. Protrusion member 7 that may act as leg members may be fixedly connected to bottom portions of the U-shaped members 4. The U-shaped members 4 may work in concert with the protrusion members 7 such that they support the top member 1 when the top member has been removed from the lifting device 27 and the top member 1 has been placed on a surface. The U-shaped members 4 may also act as legs and the protrusion members 7 may act as feet. Those skilled in the art will appreciate that the U-shaped members 4 and protrusion members 7 prevent the hoist assembly 8 from touching a surface that the top member 1 has been placed upon when the top member 1 has been removed from the lifting device 27.

With reference to FIGS. 1-4, the lifting device 27 may also include a front shield member 30 connected to the upper portions of the side members 6. The front shield member 30 may include a first shield member 10 and a second shield member 13 connected to the first shield member 10. The second shield member 13 may include a small shield square 29 located on the front facing area of the second shield member 13. The small shield square 29 may be a locking member to lock the front shield member 30 in a collapsed position when the lifting device 27 is moved from a horizontally extended position to a horizontally collapsed position, as will be discussed in greater detail below. The front shield member 30 may also include a center shield member 12 connected to a rear portion of the second shield member 13 such that it lays horizontally to slide underneath the first shield member 10 when the lifting device 27 is in the collapsed position as illustratively shown in FIG. 6. The front shield member 30 may also illustratively include a lower sliding support member 14 located at the lower end of first shield member 10 and second shield member 13. The lower sliding support member 14 may be adapted so that may be collapsed when the lifting device 27 is collapsed by a user. The front shield member 30 may also illustratively include a pair of upper sliding support members 15 on the upper portion of the front shield member oriented horizontally and preferably behind both the first shield member 10 and the second shield member 13. The upper sliding support member 15 may be adapted so that may be able to collapse when the lifting device 27 is collapsed by a user. Accordingly, the front shield member 30 may be moved between an extended position (illustrated, for example, in FIG. 1) and a collapsed position (illustrated, for example, in FIGS. 5-7). Further, the first shield member 10 slidably engages the second shield member 13 to allow for the front shield member 30 to be moved between the extended and the collapsed positions.

With reference to FIGS. 1 & 3-7, the lifting device 27 may further comprise a pair of side members 6. Each side member 6 may be adapted to allow for the bottom side of opposite ends of the top member 1 to be rested thereon. More specifically, and as perhaps best illustrated in FIG. 1, the top member 1 may be positioned to rest on the side members 6 so that the side members provide support to the top member when the lifting device 27 is in use. Each side member 6 can be made at various angles, however, it is preferable that the width of the side member 6 expands or tapers outwardly from its top to its bottom. Those skilled in the art will find a greater width of expansion of a side member 6 provides enhanced stability of the lifting device 27. Each side member 6 may also illustratively include a plurality of horizontal connecting support members 16.

Each horizontal connecting support member 16 can vary in angle and placement along the inside of each side member 6. Those skilled in the art, however, will appreciate that any number of connecting support members 16 at various angles or sizes may be provided while still accomplishing the goals, features, and objectives according to the embodiments of the present invention. The side member 6 may also include a pair of hook members 25 located on the outer side of a connecting support member 16 that may provide a place to store a remote 20.

The remote 20 may be used with the lifting device 27 to remotely control the automated characteristics of the enumerated invention which may be through wired or wireless communication via the user inputs on the remote 20. However, those skilled in the art will appreciate that a remote is not required for the embodied invention to operate. For example, the embodied invention may be operated by buttons placed elsewhere on the invention that are in communication with the hoist assembly 8 to move the hoist assembly up and down, or the lifting device 27 may be configured to operate without the need for a remote or buttons.

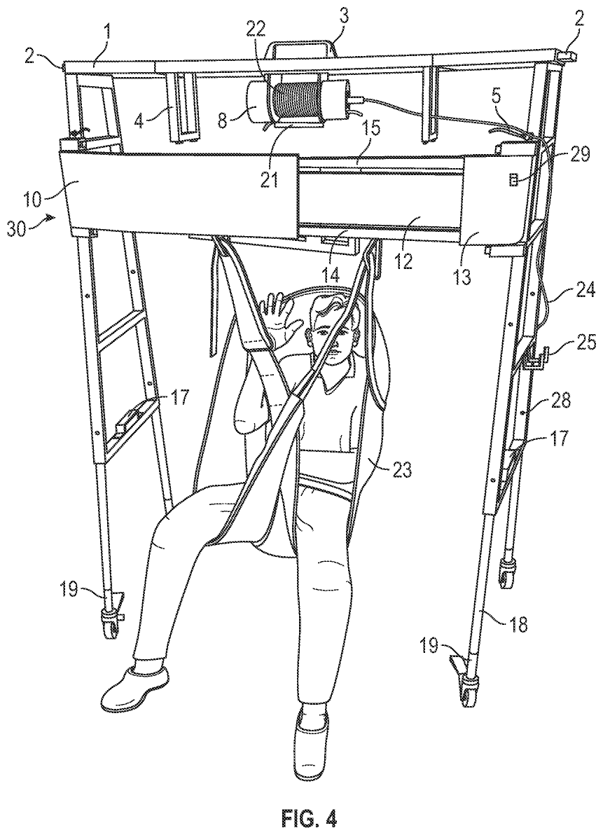

Furthermore, it is not necessary that the lifting device 27 be configured to operate by electric power and may instead be made to operate by manual force or other type of force, including but not limited to hydraulic power. In the preferred embodiment, however, the lifting device 27 which operates on electric power may comprise a wire member 24 used to supply the electric power to the hoist member 8 as illustrated, for example, in FIGS. 3 and 4. The wire member 24 may be connected to the hoist member 8 and any suitable power source. For example, for use of the lifting device 27 by ambulance personnel the lifting device 27 may be powered by plugging the wire member 24 to some power source outlet on the ambulance or other vehicle. Alternatively, the lifting device 27 may also be powered by the wire member 24 being connected to some battery supply of electric power. It is also contemplated that a battery may be included on the lifting device 27 and in electrical communication with the hoist assembly 8 to provide power so that the hoist assembly may be readily moved up and down.

Another alternative to electrically power the lifting device 27 is to have the wire member 24 transmit power from plugging into electric wall outlets. Those skilled in the art will appreciate that an electric powered lifting device 27 can be powered by a number of different sources of electric power while still accomplishing the goals, objectives, and features according to the embodiments of the present invention. In a manual configuration, those skilled in the art will appreciate that the device may include a crank member (not shown), that is connected to the coiled member 22 so that a user can crank the load member 26 to move the seat member 23 between an elevated and a lowered position.

Referring to FIGS. 1-8, lifting device 27 may also comprise of angled members 5 connected to the upper front sides of each side member 6. The angled member 5 may be used to lock the lifting device in place. The angled member 5 may work as a clamping lever used to lock the side members 28 in place to restrict the side members' 28 movement. Each angled member 5 may be turned clockwise or counterclockwise to restrict or unrestrict the movement of a side member 28. Those skilled in the art will appreciate that there are a plurality of different mechanisms that can be used to accomplish the functionality desired to restrict and unrestrict the leg members 28 while still accomplishing the goals, features, and advantages of lifting device 27.

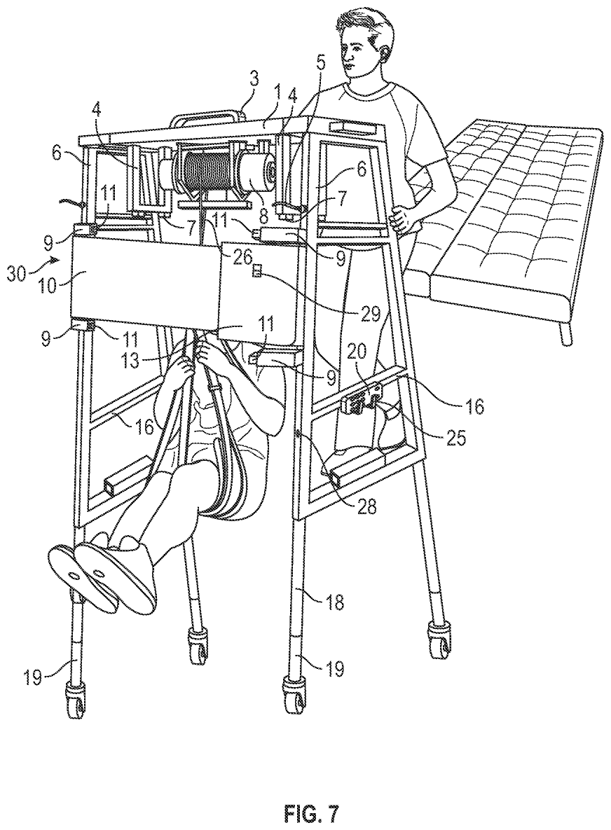

Referring now to FIGS. 1-7, the lifting device 27 may also comprise of a number of arm members 9 connected to upper front facing sides of the side members 6 that may abut sides of the front shield member 30. The lifting device 27 may also include arm cap members 11 attached to the ends of each of the arm members 9. The arm members 9 may illustratively provide enhanced support to the front shield member 30 when the front shield member 30 is connected to the side members 6 as illustrated, for example, in FIG. 7.

Referring now specifically to FIGS. 1, 3 & 4, the lifting device 27 may comprise overlay members 17 connected to the upper area of one or more of the lower connecting support members 16 and oriented parallel to the connecting support member 16 the overlay member 17 is connected to. The overlay members 17 may, for example, be used to receive a bench seat member (not shown) so that the hoist can be used to allow a patient being moved to sit while the lifting device is being used. For example, when the bench seat member is installed to be connected to the overlay members 17, the lifting device may be used to move a patient from a bed to a shower, allow the patient to be in a seated position in the shower, and remain connected to the seat member 23 to reduce a chance of falling.

Referring to FIGS. 1, 3-5, & 7, the lifting device 27 may illustratively include a number of leg members 18. Each leg member 18 may be configured to matingly slide into the lower portions of each side member 6. As perhaps best illustrated in FIG. 7, the leg members 18 are positioned to extend outwardly from each side member 6. Throughout the front facing areas of each side member 6 there may be a plurality of through holes 28 that may be used as locking mechanisms to configure the length of the leg members 18 and thus configure the height of the lifting device 27. In some embodiments, the lock mechanism in place at the through holes 28 can be a push button type lock that can be unlocked upon depression and remain locked when the button becomes raised upon ceasing depression. Alternatively, the through hole 28 locking mechanism may be a locking pin, which can be inserted once the through holes 28 align on the side member 6 and the leg member 18 in order to configure the height of the lifting device 27 by preventing longitudinal movement of the leg member 18. Other lock mechanisms may also be provided, as may be understood by those skilled in the art while still accomplishing the goals, features and advantages according to embodiments of the present invention. Moreover, the ability to raise or lower the height of the lifting device 27 advantageously allows the user to ensure the invention will be at the most convenient height given the embodied invention's intended use. For example, extending the length of the leg member 18 to a greater length advantageously allows for ease of use of the lifting device 27 over objects, such as furniture, as illustrated in FIG. 3.

The leg members 18 may also include a foot connection member 19 adapted and connected on the lower portion of each said leg member 18. This is illustratively shown in FIGS. 1, 3-5, 7, & 9. This advantageously provides enhanced stability to the lifting device. In other words, the foot connection members 19 may each have a flat configuration that may provide a more stable surface to support the lifting device 27. Those skilled in the art will appreciate that the foot connection members 19 may be inserted into a bottom portion of each of the leg members 18. Alternatively, the foot connection members 19 may be threadably connected to the leg members 18. Those skilled in the art will appreciate that there are many configurations for connecting the foot connection members 19 to the leg members 18, and each configuration that is suitable for connecting the foot connection members 19 to the leg members 18 is contemplated and intended to be included within this disclosure.

In an alternative embodiment, the foot connection members 19 may be provided by casters or other wheeled devices. Using casters advantageously allow the lifting device 27 to be readily moved after a patient has been lifted. For example, it may be desirous to lift a patient from one location and move the patient to another area simply by moving the lifting device 27 that has casters as the foot connection members 19. This advantageously provides enhanced operation of the lifting device and allows for the lifting device 27 to be used to readily move patients while simultaneously reducing the risk of injury to persons that may be necessary to lift the patient.

The lifting device 27 may also include a seat member 23 that may be attached to the lifting device 27 with the load member 26 as illustratively shown in FIGS. 3-5, and 7. A plurality of different types of seat members 23 may be used with the lifting device 27 depending on the proportions of the person to be lifted or depending upon the desired physical manipulation of the person under the current circumstances. For example, in certain situations a certain type of seat member 23 may be more desirous to lift a large person, or a different type of seat member may be more desirous if the goal is to simply lift the person to rotate them to be on his or her side. Those skilled in the art will appreciate that many different types of seat members 26 can be used while still accomplishing the goals, features, and objectives according to embodiments of the present invention.

Referring now to FIGS. 3-5, & 7, the operation of the lifting device 27 is now described in greater detail. If, for example, a patient is on the ground (or floor) and needs to be lifted therefrom, the lifting device 27 according to the present invention may be used to achieve such a task. More specifically, a seat member 23 can be engaged onto or around the patient or person that needs to be lifted from the ground. Upon engaging the seat member 23, the seat member then may be attached to the load member 26. Upon attaching the seat member 23 to the load member 26, a user may then operate the hoist assembly 8 to being rotating the coiled member 22 such that the load member 26 wraps around the coiled member 22. As the load member 26 wraps around the coiled member 22 the load member's 26 portion unwound shortens resulting in the seat member 23, and thus also the patient that the seat member is engaged upon, to be lifted above the ground.

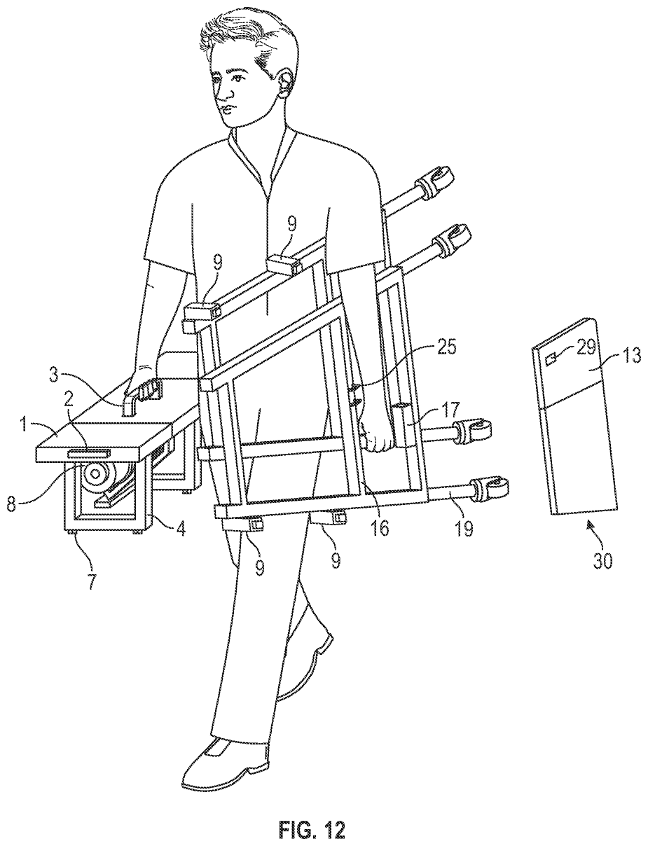

The lifting device 27 is advantageously configured for convenient setup and transportation. Referring more specifically to FIG. 10, the lifting device 27 may be disassembled and the leg members 6 may advantageously be configured to be flat for easier transportation. The top member 1 may conveniently be collapsed by a user when the lifting device 27 is disassembled. This advantageously provides for a more convenient form for which the top member 1 can be transported. Referring additionally to FIG. 11, transportation of the top member 1 is further made convenient when the carry handle member 3 is placed on the top side of the top member 1. The carry handle member 3 may provide a convenient way for a user to grip and carry the top member 1 when the lifting device 27 is disassembled. Furthermore, the front shield member 30 may also be collapsed to be in a more convenient travel form as illustrated in FIG. 12. Those skilled in the art will appreciate that it is not necessary to disassemble or collapse the lifting device 27 for transportation, and that the lifting device 27 is able to be transported in its fully assembled or uncollapsed form if needed.

Alternatively, the lifting device 27 may be transported in a fully assembled but fully collapsed form as illustrated in FIG. 6. This form is best suited when the lifting device is stored, but it is not found necessary to disassemble the lifting device 27. For example, in a hospital emergency room is may be found necessary to keep the lifting device 27 collapsed but assembled for the hospital personnel to have a faster response time when a patient has fallen onto the floor and is under emergency conditions.

As illustrated in FIG. 4, use of the hoist member 8 is optional to carry a patient around using the lifting device 27. If necessary, the seat member 23 being used with the lifting device 27 can be attached to other members (not shown) on the lifting device. For example, this may be desired when a large patient is capable of standing upright but is unable to walk (or has trouble walking), and the patient is too large to be transported easily by any other mode of transportation.

The components of the lifting device 27 according to embodiments of the present invention may advantageously be made with aluminum material. An aluminum material may be advantageous as it has high strength properties and low weight. Those skilled in the art will appreciate, however, that the lifting device 27 components may be made of any number of materials while still composting the goals, features, and objectives according to the present invention.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A lifting device comprising:
a top member;
a pair of side members attached to the top member and having a plurality of leg members;
a plurality of shield members attached to and extending between an upper portion of the pair of side members; and
a hoist member attached to a portion of the top member and having a load member carried within the hoist member;
wherein the hoist member is configured to rotate the load member between a wound position and an unwound position; and
wherein the top member and the plurality of shield members are configured to move between a collapsed position and an extended position.

2. The lifting device of claim 1, wherein the plurality of leg members are movable between an extended position and a collapsed position.

3. The lifting device of claim 2, wherein the pair of side members have a plurality of through holes formed therethrough; wherein the lifting device further comprising a locking mechanism carried by a portion of each of the leg members; and wherein the locking mechanism is configured to move between a locked state and an unlocked state.

4. The lifting device of claim 3, wherein the locked state is defined as the locking mechanism engaging a pair of the plurality of through holes formed in the side members; and wherein the unlocked state is defined as the locking mechanism not engaging the pair of through holes formed in the side members; wherein when the locking mechanism is in the unlocked state, the plurality of legs are slidably moveable with respect to the respective side members; and wherein when the locking mechanism is in the locked state, the plurality of legs are fixedly positioned with respect to the respective side members.

5. The lifting device of claim 1, wherein the plurality of leg members further comprise a respective plurality of foot connection members attached thereto, wherein the foot connection members comprise casters.

6. The lifting device of claim 1, further comprising at least one U-shaped member attached to a bottom side of the top member.

7. The lifting device of claim 1, wherein the hoist member is coupled in communication with a remote device, and wherein the hoist member is configured to be controlled by the remote device via user inputs on the remote device.

8. The lifting device of claim 7, wherein the communication between the remote device and the hoist member is at least one of wired and wireless communication.

9. The lifting device of claim 1, further comprising a pair of overlay members; wherein one of the pair of overlay members is connected to one of a plurality of support members that extends between portions of the side members; wherein the pair of overlay members are horizontally aligned with one another; and wherein the pair of overlay members are configured to receive a bench seat.

10. The lifting device of claim 1, wherein the top member includes a medial portion and a pair of side portions that are slidably connected to the medial portion; wherein the medial portion includes a pair of cavities configured to receive the respective pair of side portions; wherein the collapsed position of the top member is defined as the pair of side portions being slid into the respective cavities; and wherein the extended position of the top member is defined as the pair of side members being extended out from the respective pair of cavities.

11. The lifting device of claim 10, wherein the top member comprises a top handle member positioned on an upper portion of the top member and opposing side handle members connected to each of the respective pair of side portions so that each of the side portions of the top member includes one side handle member.

12. The lifting device of claim 1, wherein the plurality of shield members comprises a first shield member, a second shield member, and a center shield member; wherein a side of the center shield member is attached to the second shield member; wherein another side of the center shield member is slidably attached to the first shield member; wherein the plurality of shield members are configured to move between a collapsed position and an extended position; wherein the collapsed position is defined as the center shield member being substantially covered by the first shield member; and wherein the extended position is defined as at least a portion of the center shield member being uncovered by the first shield member.

13. The lifting device of claim 12, wherein the second shield member further comprises a shield lock; wherein the shield lock is configured to move between a locked state and an unlocked state; wherein when the shield lock is in the locked state, the first shield member is prevented from sliding with respect to the center shield member; and wherein when the shield lock is in the unlocked sate, the first shield member is slidable with respect to the center shield member.

14. The lifting device of claim 1, wherein the pair of side members are removably attachable to the top member; wherein the plurality of shield members are removably attachable to the side members; and wherein the lifting device is moveable between a disassembled state and an assembled state.

15. The lifting device of claim 14, wherein the disassembled state is defined as the pair of side members being detached from the top member and the plurality of shield members being detached from the pair of side members; wherein the assembled state is defined as the pair of side members being attached to the top member and the plurality of shield members being attached to the pair of side members.

16. A lifting device comprising:
a top member;
a pair of side members removably attached to the top member and having a plurality of leg members;
a plurality of shield members removably attached to and extending between an upper portion of the pair of side members;
a hoist member attached to a portion of the top member and configured to carry a seat member via a load member attached thereto;
a pair of U-shaped members attached to a bottom side of the top member; and
a plurality of protrusion members connected to a bottom portion of each of the U-shaped members;
wherein the plurality of leg members are configured to be movable between an extended position and a collapsed position;
wherein the lifting device is moveable between a disassembled state and an assembled state;
wherein the disassembled state is defined as the pair of side members being detached from the top member and the plurality of shield members being detached from the pair of side members; and
wherein the assembled state is defined as the pair of side members being attached to the top member and the plurality of shield members being attached to the pair of side members.

17. The lifting device of claim 16, wherein the pair of side members have a plurality of through holes formed therethrough; wherein the lifting device further comprising a locking mechanism carried by a portion of each of the leg members; and wherein the locking mechanism is configured to move between a locked state and an unlocked state.

18. The lifting device of claim 17, wherein the locked state is defined as the locking mechanism engaging a pair of the plurality of through holes formed in the side members; and wherein the unlocked state is defined as the locking mechanism not engaging the pair of through holes formed in the side members; wherein when the locking mechanism is in the unlocked state, the plurality of legs can be slidably moved with respect to the respective side members; and wherein when the locking mechanism is in the locked state, the plurality of legs are fixedly positioned with respect to the respective side members.

19. The lifting device of claim 16, wherein the plurality of leg members further comprise a respective plurality of foot connection members attached thereto, wherein the foot connection members comprise casters.

20. The lifting device of claim 16, wherein the hoist member is coupled in communication with a remote device, and wherein the hoist member is configured to be controlled by the remote device via user inputs on the remote device; and wherein the communication between the remote device and the hoist member is at least one of wired and wireless communication.

21. The lifting device of claim 16, further comprising a pair of overlay members; wherein one of the pair of overlay members is connected to one of a plurality of support members that extends between portions of the side members; wherein the pair of overlay members are horizontally aligned with one another; and wherein the pair of overlay members are configured to receive a bench seat.

22. The lifting device of claim 16, wherein the top member includes a medial portion and a pair of side portions that are slidably connected to the medial portion; wherein the medial portion includes a pair of cavities configured to receive the respective pair of side portions; wherein the collapsed position of the top member is defined as the pair of side portions being slid into the respective cavities; wherein the extended position of the top member is defined as the pair of side members being extended out from the respective pair of cavities; and wherein the top member comprises a top handle member positioned on an upper portion of the top member and a pair of opposing side handle members connected to each of the respective pair of side portions.

23. The lifting device of claim 16, wherein the plurality of shield members comprises a first shield member, a second shield member, and a center shield member; wherein a side of the center shield member is attached to the second shield member; wherein another side of the center shield member is slidably attached to the first shield member; wherein the plurality of shield members are configured to move between a collapsed position and an extended position; wherein the collapsed position is defined as the center shield member being substantially covered by the first shield member; and wherein the extended position is defined as at least a portion of the center shield member being uncovered by the first shield member.

24. The lifting device of claim 23, wherein the second shield member further comprises a shield lock; wherein the shield lock is configured to move between a locked state and an unlocked state; wherein when the shield lock is in the locked state, the first shield member is prevented from sliding with respect to the center shield member; and wherein when the shield lock is in the unlocked sate, the first shield member is slidable with respect to the center shield member.

25. A lifting device comprising:
a top member including a medial portion and a pair of side portions that are slidably connected to the medial portion, the medial portion including a pair of cavities configured to receive the respective pair of side portions;
a pair of side members removably attachable to the top member and having a plurality of leg members, the plurality of leg members being movable between an extended position and a collapsed position;
a plurality of shield members removably attachable to and extending between an upper portion of the pair of side members, the plurality of shield members comprising a first shield member, a second shield member having a shield lock, and a center shield member;
a hoist member attached to a portion of the top member and having a load member carried within the hoist member; and
a locking mechanism carried by a portion of each of the leg members and configured to move between a locked state and an unlocked state;
wherein the pair of side members have a plurality of through holes formed therethrough positioned to align with the locking mechanisms;
wherein the locked state of the locking mechanism is defined as the locking mechanism engaging a pair of the plurality of through holes formed in the side members;
wherein the unlocked state of the locking mechanism is defined as the locking mechanism not engaging the pair of through holes formed in the side members;
wherein when the locking mechanism is in the unlocked state, the plurality of legs are slidably moveable with respect to the respective side members;
wherein when the locking mechanism is in the locked state, the plurality of legs are fixedly positioned with respect to the respective side members;
wherein the hoist member is configured to rotate the load member between a wound position and an unwound position;
wherein a side of the center shield member is attached to the second shield member;
wherein another side of the center shield member is slidably attached to the first shield member;
wherein the plurality of shield members are configured to move between a collapsed position and an extended position;
wherein the collapsed position of the plurality of shield members is defined as the center shield member being substantially covered by the first shield member;
wherein the extended position of the plurality of shield members is defined as at least a portion of the center shield member being uncovered by the first shield member;
wherein the shield lock is configured to move between a locked state and an unlocked state;
wherein when the shield lock is in the locked state, the first shield member is prevented from sliding with respect to the center shield member;
wherein when the shield lock is in the unlocked sate, the first shield member is slidable with respect to the center shield member;
wherein the top member is configured to move between a collapsed position and an extended position;
wherein the collapsed position of the top member is defined as the pair of side portions being slid into the respective pair of cavities;
wherein the extended position of the top member is defined as the pair of side members being extended out from the respective pair of cavities;
wherein the lifting device is moveable between a disassembled state and an assembled state;
wherein the disassembled state is defined as the pair of side members being detached from the top member and the plurality of shield members being detached from the pair of side members; and
wherein the assembled state is defined as the pair of side members being attached to the top member and the plurality of shield members being attached to the pair of side members.

26. The lifting device of claim 25, wherein the hoist member is coupled in communication with a remote device; wherein the hoist member is configured to be controlled by the remote device via user inputs on the remote device; and wherein the communication between the remote device and the hoist member is at least one of wired and wireless communication.

27. The lifting device of claim 25, further comprising a pair of overlay members; wherein one of the pair of overlay members is connected to one of a plurality of support members that extends between portions of the side members; wherein the pair of overlay members are horizontally aligned with one another; and wherein the pair of overlay members are configured to receive a bench seat.

28. The lifting device of claim 25, wherein the top member comprises a top handle member positioned on an upper portion of the top member and opposing side handle members connected to each of the respective pair of side portions so that each of the side portions of the top member includes one side handle member.
